(19) United States
(12) Patent Application Publication
(10) Pub. No.: US 2025/0380146 A1
(43) Pub. Date: Dec. 11, 2025

(54) CONTROL APPARATUS, CONTROL METHOD AND PROGRAM

(71) Applicant: NIPPON TELEGRAPH AND TELEPHONE CORPORATION, Tokyo (JP)

(72) Inventors: Kotaro ONO, Tokyo (JP); Kazuhiro TOKUNAGA, Tokyo (JP); Takeshi KUWAHARA, Tokyo (JP)

(21) Appl. No.: 18/875,962

(22) PCT Filed: Jun. 20, 2022
(86) PCT No.: PCT/JP2022/024609

§ 371 Date: Dec. 17, 2024

(51) Int. Cl. H04W 16/14; H04W 64/00

(52) U.S. Cl. CPC H04W 16/14; H04W 64/00

(57) ABSTRACT

A control device according to one aspect of the present disclosure is a control device to be connected to a mobile terminal including at least a GNSS receiver via a communication network, and includes a control unit configured to control resources available to the mobile terminal in accordance with a reception status of a GNSS signal in the GNSS receiver included in the mobile terminal.

### TECHNICAL FIELD

The present disclosure relates to a control device, a control method, and a program.

### BACKGROUND ART

In recent years, methods for acquiring position information have been diversified/advanced, and it has been required to acquire position information in accordance with environments and requirements. For example, in addition to a positioning calculation method using a global navigation satellite system (GNSS) signal, there are various positioning calculation methods that do not use a GNSS signal, such as dead reckoning and image positioning. In addition, as a positioning calculation method using a GNSS signal, there is also an advanced and highly accurate method such as real time kinematic (RTK) positioning as well as a relatively low accurate method such as code positioning.

Regarding measurement of position information, an architecture (cloud GNSS positioning architecture) in which positioning calculation is performed on an edge/cloud instead of positioning calculation being performed on a mobile terminal side that receives a GNSS signal has been proposed (Non Patent Literature 1). In this cloud GNSS positioning architecture, a mobile terminal transmits observation data of a GNSS signal to an edge/cloud, and positioning calculation of position information of the mobile terminal is performed on the edge/cloud from the observation data.

On the other hand, in view of diversification of methods for acquiring position information, even in the architecture proposed in Non Patent Literature 1, it is also expected that positioning calculation of position information of the mobile terminal is performed on the edge/cloud using a positioning calculation method that does not use a GNSS signal in addition to a positioning calculation method using a GNSS signal. Furthermore, even in a case where positioning calculation of position information is performed using a positioning calculation method using a GNSS signal, it is also expected that sensor information such as an image acquired by the mobile terminal is supplementarily or additionally used to perform positioning with higher accuracy.

### CITATION LIST

### Non Patent Literature

Non Patent Literature 1: Seiji Yoshida, Takahito Kirihara, Shunichi Tsuboi, Tsuyoshi Toyono, Takeshi Kuwahara, “High Value-Added Position Information Service by Coordination of GNSS and Network”, NTT Technical Journal, 2019. 4

### SUMMARY OF INVENTION

### Technical Problem

However, in a case where a number of mobile terminals transmit sensor information such as images to the edge/cloud, there is a possibility that communication resources such as a communication band, server resources on the edge/cloud, and the like, may be congested.

The present disclosure has been made in view of the above points, and an object of the present disclosure is to provide a technique for improving efficiency of use of resources involved with acquisition of position information.

### Solution to Problem

A control device according to one aspect of the present disclosure is a control device to be connected to a mobile terminal including at least a GNSS receiver via a communication network, and includes a control unit configured to control resources available to the mobile terminal in accordance with a reception status of a GNSS signal in the GNSS receiver included in the mobile terminal.

### Advantageous Effects of Invention

A technique for improving efficiency of use of resources involved with acquisition of position information is provided.

### BRIEF DESCRIPTION OF DRAWINGS

FIG. 1 is a view illustrating an overall configuration example of a communication control system according to the present embodiment.

FIG. 2 is a view illustrating a functional configuration example of a mobile terminal according to the present embodiment.

FIG. 3 is a view illustrating a functional configuration example of a control server according to the present embodiment.

FIG. 4 is a flowchart indicating an example of position information data storage processing according to the present embodiment.

FIG. 5 is a flowchart (part 1) indicating an example of NW control processing according to the present embodiment.

FIG. 6 is a flowchart (part 2) indicating an example of the NW control processing according to the present embodiment.

### DESCRIPTION OF EMBODIMENTS

Hereinafter, one embodiment of the present invention will be described. Hereinafter, a communication control system 1 in which communication resources such as a communication band are mainly assumed as resources and which improves efficiency of use of the communication resources involved with acquisition of position information will be described. However, this is an example, and the resources involved with acquisition of the position information are not limited to the communication resources. For example, even for edge/cloud-side server resources (for example, various hardware resources such as central processing unit (CPU) resources, graphics processing unit (GPU) resources, and memory resources) in a cloud GNSS architecture, the embodiment described below can be similarly applied.

Hereinafter, positioning calculation using a GNSS signal will be referred to as GNSS positioning. Examples of the GNSS positioning include code positioning, RTK positioning, and the like. Note that code positioning is GNSS positioning classified as single positioning, and RTK positioning is classified as relative positioning. In the relative positioning, position information is determined from a relative positional relationship between two points, and thus, a reference station whose position information is known needs to exist. On the other hand, positioning calculation that does not use a GNSS signal will be referred to as non-GNSS positioning. Examples of the non-GNSS positioning include dead reckoning and image positioning. In addition to these, supplementary or additional processing (for example, collation with a high-definition map and estimation of position information using three-dimensional or four-dimensional space information) for increasing accuracy of GNSS positioning will be also referred to as non-GNSS positioning.

### <Overall Configuration Example of Communication Control System 1>

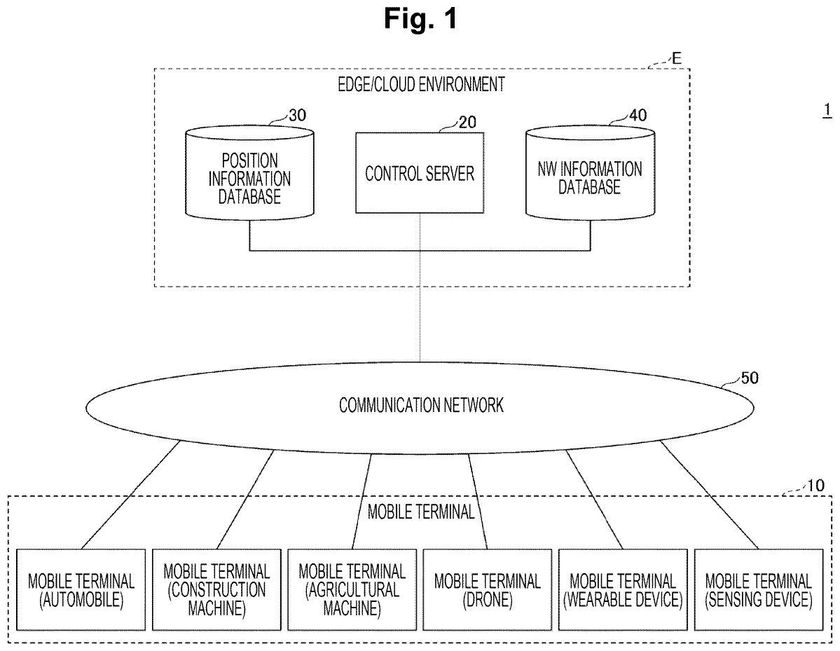

FIG. 1 illustrates an overall configuration example of the communication control system 1 according to the present embodiment. As illustrated in FIG. 1, the communication control system 1 according to the present embodiment includes a plurality of mobile terminals 10, a control server 20, a position information database 30, and an NW information database 40. In addition, each mobile terminal 10 and the control server 20 are communicably connected via a communication network 50 including, for example, the Internet. Note that the control server 20, the position information database 30, and the NW information database 40 are arranged, for example, in an edge/cloud environment E which is a system environment existing on an edge or a cloud for each of the mobile terminals 10.

The mobile terminals 10 are various kinds of terminals mounted on or possessed by mobile objects (such as, for example, an automobile, construction machine, agricultural machine, a drone, a person and an animal). Examples of the mobile terminals 10 include an in-vehicle device mounted on a vehicle such as an automobile, construction machine, or agricultural machine, equipment mounted on a drone, a wearable device or a sensing device mounted on a person or an animal, a smartphone or a tablet terminal possessed by a person, and the like.

The mobile terminal 10 includes at least a GNSS receiver (GNSS receiver) and can receive a signal (GNSS signal) from a GNSS satellite. In addition, the mobile terminal 10 transmits the received GNSS signal to the control server 20 as observation data (which may be referred to as Raw data).

Here, the mobile terminal 10 includes various sensors (including an imaging device such as a camera) according to the type in addition to the GNSS receiver and also transmits sensor information acquired or measured by these sensors to the control server 20. These pieces of sensor information are used for non-GNSS positioning. Examples of the sensor include a camera, an acceleration sensor (including a three-axis acceleration sensor), a gyro sensor (including a three-axis gyro sensor), an inertial measurement unit (IMU), and the like. What kind of sensor the mobile terminal 10 includes may vary depending on the type of the mobile terminal 10.

Note that the mobile terminal 10 may have a function (terminal-side positioning calculation function) of measuring own position information from the received GNSS signal. However, in the present embodiment, the mobile terminal 10 does not necessarily have the terminal-side positioning calculation function. Thus, there may be a situation where, for example, a certain mobile terminal 10 has the terminal-side positioning calculation function, but another certain mobile terminal 10 does not have the terminal-side positioning calculation function or may be a situation where all the mobile terminals 10 have (or not have) the terminal-side positioning calculation function.

The control server 20 is a general-purpose server, or the like, that measures the position information of the mobile terminal 10 using the observation data and the sensor information received from the mobile terminal 10 and controls resources available to the mobile terminal 10 in response to occurrence of a certain specific event. Here, details of the specific event will be described later, but in the present embodiment, an event in which the position information of the mobile terminal 10 cannot be measured through GNSS positioning will be mainly assumed. In other words, an event will be assumed in which the mobile terminal 10 is in a situation where the mobile terminal 10 cannot receive the GNSS signal (or reception of the GNSS signal is unstable) mainly because the mobile terminal 10 is in a shielded space such as inside a tunnel or indoors. In addition, as control of the resources, mainly, control of increasing communication resources available to the mobile terminal 10 or increasing the priority in a case where the position information of the mobile terminal 10 cannot be measured through GNSS positioning, and control of reducing communication resources available to the mobile terminal 10 and lowering the priority in a case where the position information of the mobile terminal 10 can be measured through GNSS positioning, are assumed. As a result, for example, in a case where GNSS positioning can be performed, it is possible to prevent congestion of communication resources due to transmission of high-rate or large-capacity sensor information from the mobile terminal 10. On the other hand, for example, in a case where GNSS positioning cannot be performed, the position information of the mobile terminal 10 can be measured by performing non-GNSS positioning using the sensor information transmitted from the mobile terminal 10.

Note that the control server 20 may perform, for example, various kinds of processing (for example, application processing, or the like, for providing some kind of service to the mobile terminal 10) using the position information in addition to measurement of the position information of the mobile terminal 10 and resource control. In addition to resource control, the control server 20 may control various functions of the mobile terminal 10 (for example, control of activating or stopping a sensor such as a camera, remote control of other kinds of functions, and the like). In particular, control of various functions of the mobile terminal 10 may include real-time control (that is, control of implementing activation, execution, stop, and the like, of some kind of function in real time).

The position information database 30 is a database server that stores data (hereinafter, the position information data is also referred to as position information data) including position information measured by the control server 20 (and the position information measured by the mobile terminal 10 in a case where the mobile terminal 10 has a terminal-side positioning calculation function). Here, in the position information database 30, for example, position information data is stored in a format of (terminal ID, a time point, position information, calculation source). The terminal ID is identification information for identifying the mobile terminal 10. The time point is information indicating a date and time when the position information is measured. The calculation source is information indicating a type of information used for measuring the position information. In the following, as an example, it is assumed that any one of a GNSS base, an IMU base, an image recognition base, an NW information base, and a combination can be set as the calculation source. The GNSS base indicates that position information is measured using a GNSS signal (that is, the position information is measured by GNSS positioning). The IMU base indicates that the position information is measured by using the sensor information (acceleration, angular velocity) obtained from an inertial measurement device (hereinafter, this positioning method will be also referred to as IMU positioning). The image recognition base indicates that the position information is measured using an image obtained from an imaging device such as a camera (that is, the position information is measured by image positioning). The NW information base indicates that the position information is measured using information (such as, for example, radio wave intensity and beacon) obtained from wireless communication used by the mobile terminal 10 (hereinafter, this positioning method will be also referred to as NW information positioning). The combination indicates that the position information is measured using two or more kinds of non-GNSS positioning

(IMU positioning, image positioning, NW information positioning). Note that, for highly accurate GNSS positioning, in a case where non-GNSS positioning is supplementarily or additionally performed in addition to GNSS positioning, the “GNSS base” is set as the calculation source.

Note that image positioning can include not only estimation of position information by collation with a high-definition map and estimation of position information by utilizing three-dimensional or four-dimensional space information, but also, for example, estimation of position information by collation between a white line detected on a road using an image recognition technology and lane information, estimation of position information by collation with a high-definition video, estimation of position information by collation between an object detected using a sensor such as a laser and a high-definition map (including a dynamic map and the like), and the like.

The NW information database 40 is a database server that stores first NW information data including NW information of the mobile terminal 10 and second NW information data including a NW of a NW facility (such as, for example, a radio base station and an access point). Here, in the NW information database 40, for example, the first NW information data is stored in a format of (terminal ID, NW information). The NW information is information such as a network route, priority, and network quality information (such as, for example, bandwidth, delay and jitter) used by the mobile terminal 10 identified by the terminal ID. In addition, for example, the second NW information data is stored in a format of (NW facility ID, use situation). The NW facility ID is identification information for identifying the NW facility. The use situation is information (such as, for example, a bandwidth use rate of the NW facility, the number of connections of the mobile terminal 10 using the NW facility, and the number of available connections indicating how much more connections are possible) indicating the use situation of the NW facility identified by the NW facility ID. Note that the second NW information data may include, for example, information indicating the terminal ID, or the like, of the mobile terminal 10 that can use the NW facility identified by the NW facility ID.

Note that the overall configuration of the communication control system 1 illustrated in FIG. 1 is an example, and the present invention is not limited thereto.

For example, in an edge/cloud environment E, various servers, equipment, devices, and the like, may exist in addition to the control server 20, the position information database 30, and the NW information database 40. For example, there may be an application server that executes the application processing described above, or there may be a reference station database that stores data including information regarding the reference station (such as, for example, a range of a position where the reference station becomes the nearest reference station).

### <Functional Configuration Example of Mobile Terminal 10 and Control Server 20>

Hereinafter, functional configuration examples of the mobile terminal 10 and the control server 20 according to the present embodiment will be described.

### <<Mobile Terminal 10>>

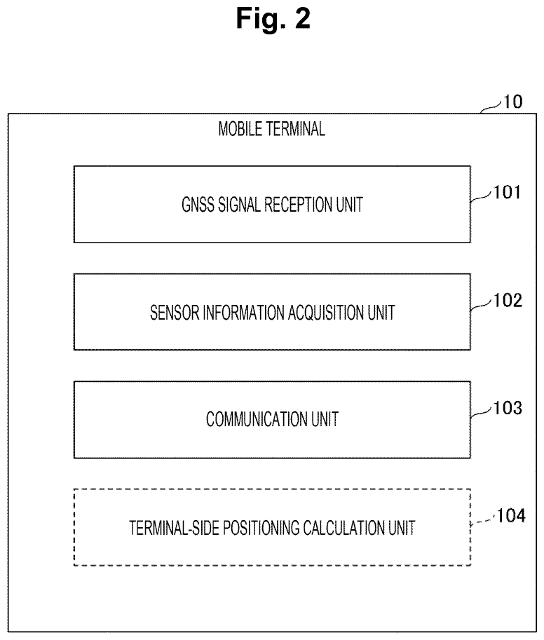

FIG. 2 illustrates a functional configuration example of the mobile terminal 10 according to the present embodiment. As illustrated in FIG. 2, the mobile terminal 10 according to the present embodiment includes a GNSS signal reception unit 101, a sensor information acquisition unit 102, and a communication unit 103. Furthermore, the mobile terminal 10 according to the present embodiment may include a terminal-side positioning calculation unit 104. Each of these functional units is implemented by, for example, one or more programs installed in the mobile terminal 10, an arithmetic device such as a CPU that executes processing according to the programs, a GNSS receiver, various sensors, an interface device for connecting to the communication network 50, and the like.

The GNSS signal reception unit 101 receives a GNSS signal from a GNSS satellite. The sensor information acquisition unit 102 acquires sensor information from various sensors. The communication unit 103 transmits the GNSS signal received by the GNSS signal reception unit 101 to the control server 20 and transmits the sensor information acquired by the sensor information acquisition unit 102 to the control server 20. Note that, when transmitting the GNSS signal and the sensor information, the communication unit 103 also transmits, for example, its own terminal ID, and the like, to the control server 20. The terminal-side positioning calculation unit 104 measures position information by GNSS positioning using the GNSS signal received by the GNSS signal reception unit 101.

Note that the GNSS signal reception unit 101 receives the GNSS signal at a predetermined signal reception cycle. However, there may be a case where the GNSS signal cannot be received depending on a situation of the mobile terminal 10 (for example, in a shielded space such as in a tunnel or indoors). Similarly, the sensor information acquisition unit 102 acquires sensor information from the corresponding sensor at a predetermined sensing cycle.

<<Control server 20>>

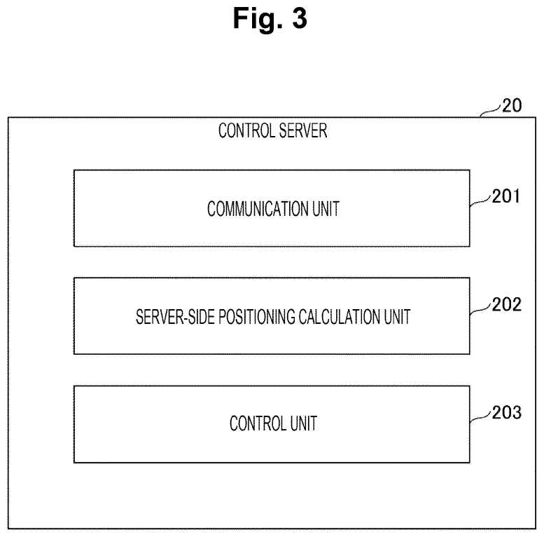

FIG. 3 illustrates a functional configuration example of the control server 20 according to the present embodiment. As illustrated in FIG. 3, the control server 20 according to the present embodiment includes a communication unit 201, a server-side positioning calculation unit 202, and a control unit 203. These functional units are implemented by, for example, one or more programs installed in the control server 20, an arithmetic device such as a CPU that executes processing according to these programs, an interface device for connecting to the communication network 50, and the like.

The communication unit 201 receives a GNSS signal from the mobile terminal 10 and receives sensor information. The server-side positioning calculation unit 202 uses at least one of the GNSS signal or the sensor information received by the communication unit 201 to measure the position information of the mobile terminal 10 that is a transmission source of the GNSS signal and the sensor information. In a case where a certain specific event (for example, an event in which the GNSS signal cannot be received (or reception of the GNSS signal is unstable)) occurs, the control unit 203 controls communication resources available to the mobile terminal 10 in which the event has occurred.

### <Position Information Data Storage Processing>

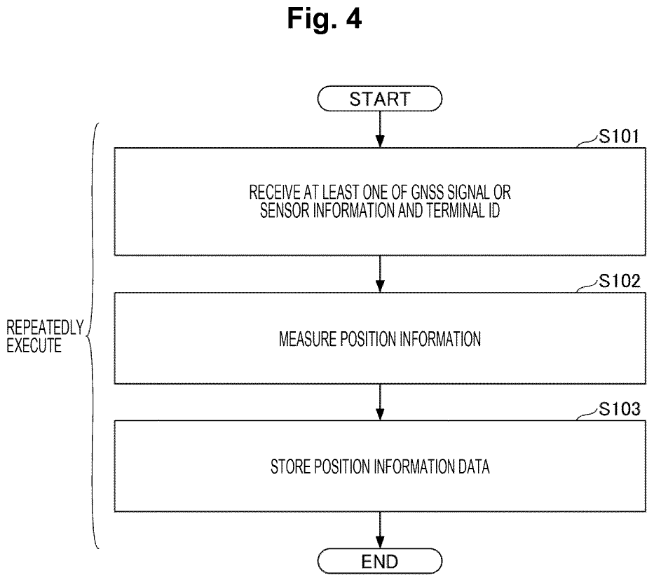

Hereinafter, processing of storing position information data in the position information database will be described with reference to FIG. 4. Note that the following step S101 to step S103 are repeatedly executed each time at least one of the GNSS signal or the sensor information is transmitted from each mobile terminal 10.

The communication unit 201 of the control server 20 receives at least one of the GNSS signal or the sensor information (that is, the GNSS signal or the sensor information, or both of them) and the terminal ID (step S101).

Next, the server-side positioning calculation unit 202 of the control server 20 uses the GNSS signal or the sensor information, or both, to measure the position information of the mobile terminal 10 identified by the terminal ID (step S102). In this event, in a case where only the GNSS signal is received in step S101 described above, the server-side positioning calculation unit 202 measures the position information of the mobile terminal 10 through GNSS positioning. Furthermore, in a case where only the sensor information is received in step S101 described above, the server-side positioning calculation unit 202 measures the position information of the mobile terminal 10 through non-GNSS positioning. Furthermore, in a case where both the GNSS signal and the sensor information are received in step S101 described above, the server-side positioning calculation unit 202 may perform only GNSS positioning or may perform highly accurate GNSS positioning by performing supplementary or additional non-GNSS positioning using the sensor information.

Then, the server-side positioning calculation unit 202 of the control server 20 stores, in the position information database 30, the position information data (terminal ID, time point, position information, calculation source) including the terminal ID, the time point when positioning is performed in step S102 described above, the position information that is a positioning result, and the calculation source (step S103). Here, as the calculation source, the “GNSS base” is set in a case where GNSS positioning is performed in the above-described step S102 (or in a case where in addition to GNSS positioning, the non-GNSS positioning is supplementarily or additionally performed), the “IMU base” is set in a case where IMU positioning is performed, the “image recognition base” is set in a case where image positioning is performed, the “NW information base” is set in a case where NW information positioning is performed, and the “combination” is set in a case where two or more kinds of non-GNSS positioning (IMU positioning, image positioning, NW information positioning) are performed.

Note that, in the above example, a case where the server-side positioning calculation unit 202 of the control server 20 measures the position information of the mobile terminal 10 has been described, but the position information may be measured by the terminal-side positioning calculation unit 104. In this case, the position information measured by the terminal-side positioning calculation unit 104 is transmitted from the mobile terminal 10 to the control server 20, and position information data including the position information is stored in the position information database 30 by the control server 20. In this event, the position information is measured using the GNSS signal, and thus, the calculation source is the “GNSS base”.

### <NW Control Processing (Part 1)>

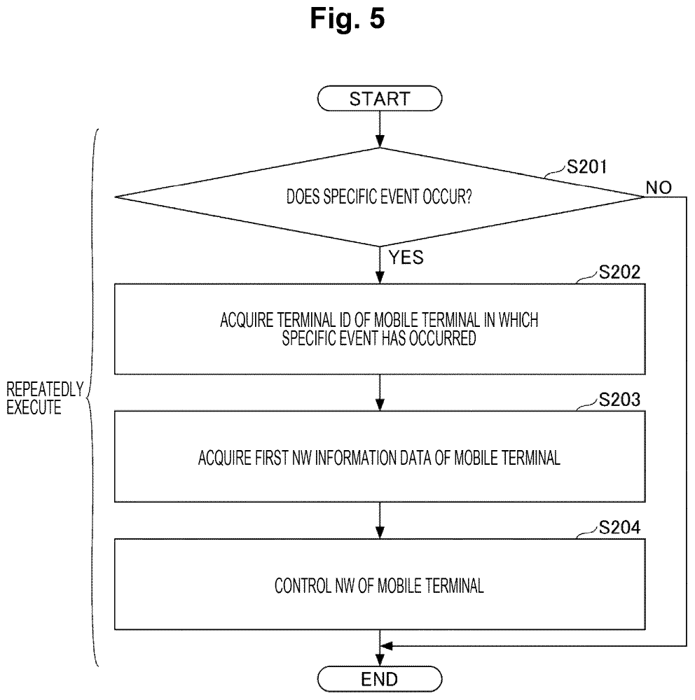

Hereinafter, processing of controlling communication resources available to the mobile terminal 10 in which a certain event has occurred in a case where the event has occurred will be described with reference to FIG. 5. Note that the following step S201 to step S204 are repeatedly executed at predetermined time intervals.

The control unit 203 of the control server 20 determines whether or not a specific event has occurred in a certain mobile terminal 10 from the position information data stored in the position information database 30 (step S201). For example, in a case where any one of the following (1-1) to (1-3) is detected, the control unit 203 determines that a specific event has occurred in the mobile terminal 10 having the terminal ID included in the detected position information data.

(1-1) A case where position information data in which calculation source is other than the “GNSS base” is newly stored in the position information database 30.

In this case, it is considered that the mobile terminal 10 having the terminal ID included in the position information data cannot receive a GNSS signal.

(1-2) A case where position information data in which time point and position information are blank is newly stored in the position information database 30.

In this case, it is considered in a similar manner, that the mobile terminal 10 having the terminal ID included in the position information data cannot receive a GNSS signal. In addition, in this case, it is considered that measurement of the position information cannot be performed, and not only the GNSS signal cannot be received but also the sensor information cannot be acquired or transmitted. Note that, in (2), it is assumed that the position information data is stored in the position information database 30 at a predetermined cycle regardless of whether or not the position information is measured.

(1-3) A case where a time point and position information of the position information data of a certain mobile terminal 10 are not updated at a predetermined update frequency.

In this case, it is considered that the mobile terminal 10 cannot receive the GNSS signal (or reception of the GNSS signal is unstable).

Note that the above (1-1) to (1-3) are all examples, and the present invention is not limited thereto. The control unit 203 can determine that an event in which a GNSS signal cannot be received (or reception of the GNSS signal is unstable) has occurred in a certain mobile terminal 10 using an arbitrary method. For example, it is assumed that the mobile terminal 10 includes the terminal-side positioning calculation unit 104, and the control server 20 receives the position information from the mobile terminal 10 at predetermined time intervals. In this case, when the position information has not been transmitted from the mobile terminal 10 even after the time interval has elapsed, the control unit 203 of the control server 20 may determine that an event in which a GNSS signal cannot be received (or reception of the GNSS signal is unstable) has occurred in the mobile terminal 10.

In a case where it is not determined in step S201 that a specific event has occurred (step S201: No), the control unit 203 of the control server 20 ends the processing. On the other hand, in a case where it is determined in step S201 that a specific event has occurred (step S201: Yes), the control unit 203 of the control server 20 acquires the terminal ID of the mobile terminal 10 in which the event has occurred from the position information data detected in step S201 (step S202).

Next, the control unit 203 of the control server 20 acquires the first NW information data including the terminal ID acquired in the above step S202 from the NW information database 40 (step S203).

Then, the control unit 203 of the control server 20 performs control to increase the communication resources of the mobile terminal 10 by using the NW information included in the first NW information data acquired in the above step S203 (step S204). For example, the control unit 203 executes any one or more of the following (A) to (D). Note that the control of the communication resources can be implemented using a known method.

(A) The network route of the mobile terminal 10 is changed to a route with better network quality (such as, for example, a route with a wider bandwidth and a route with less jitter, delay, or the like).

In this case, for example, it can be considered that the control unit 203 refers to a use situation of the second NW information data, and the like, and changes the network route of the mobile terminal 10 so as to pass through the NW facility with a small bandwidth use rate and a small number of connections. This can improve the network quality of the mobile terminal 10.

(B) The bandwidth of the mobile terminal 10 is increased.

In this case, for example, it can be considered that the control unit 203 determines an increased bandwidth using a predetermined method and allocates the determined bandwidth to the mobile terminal 10. This can improve network quality of the mobile terminal 10 in a similar manner to (A) described above.

(C) The priority of the mobile terminal 10 is increased.

In this case, for example, it can be considered that the control unit 203 determines the priority after being increased using a predetermined method and allocates the determined priority to the mobile terminal 10. This can improve the network quality of the mobile terminal 10 in a similar manner to (A) and (B) described above.

In a case where the communication resources of a certain mobile terminal 10 are increased by the above step S204, the NW information of the first NW information data including the terminal ID of the mobile terminal 10 is also updated.

As described above, the control server 20 according to the present embodiment can increase the communication resources of the mobile terminal 10 that is the mobile terminal 10 in a situation where the GNSS signal cannot be received (or reception of the GNSS signal is unstable). As a result, the mobile terminal 10 can transmit sensor information to the control server 20 in real time or transmit sensor information at a high rate or with high accuracy. Thus, highly accurate non-GNSS positioning can be performed on the control server 20 side, and highly accurate position information can be obtained even in a case where GNSS positioning cannot be performed.

### <NW Control Processing (Part 2)>

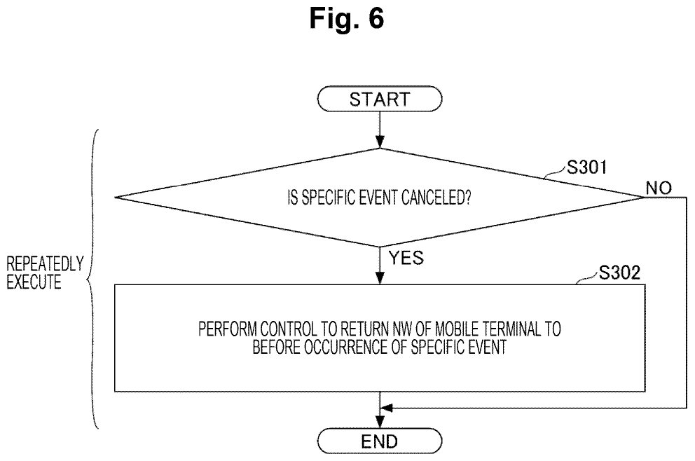

Hereinafter, processing of, in a case where occurrence of a specific event has been eliminated, controlling available communication resources of the mobile terminal 10 in which the occurrence of the event has been eliminated will be described with reference to FIG. 6. Note that the following step S301 to step S302 are repeatedly executed at predetermined time intervals.

Regarding the mobile terminal 10 in which a certain specific event has occurred, the control unit 203 of the control server 20 determines whether or not the event has been canceled from the position information data stored in the position information database 30 (step S301). For example, in a case where any one of the following (2-1) to (2-3) is detected for the mobile terminal 10 in which a specific event has occurred, the control unit 203 determines that the specific event that has occurred in the mobile terminal 10 has been canceled.

(2-1) A case where, in a case where it is determined that a specific event has occurred according to (1-1) described above, position information data which includes the terminal ID of the mobile terminal 10 and in which calculation source is the “GNSS base” is stored in the position information database 30.

(2-2) A case where, in a case where it is determined that a specific event has occurred according to (1-2) described above, position information data which includes the terminal ID of the mobile terminal 10 and in which the time point and the position information are set is stored in the position information database 30.

(2-3) A case where, in a case where it is determined that a specific event has occurred according to (1-3) described above, an update frequency of the time point and the position information of the position information data including the terminal ID of the mobile terminal 10 has reached a predetermined update frequency.

This is because, in any of the above (2-1) to (2-3), it is considered that the mobile terminal 10 is in a situation where the mobile terminal 10 can receive the GNSS signal (or reception of the GNSS signal becomes stable).

Note that the above (2-1) to (2-3) are all examples, and the present invention is not limited thereto. The control unit 203 can determine that the situation in which the GNSS signal cannot be received (or reception of the GNSS signal is unstable) has been resolved using an arbitrary method. For example, it is assumed that the mobile terminal 10 includes the terminal-side positioning calculation unit 104, and the control server 20 receives the position information from the mobile terminal 10 at predetermined time intervals. In this case, when the position information is transmitted from the mobile terminal 10, the control unit 203 of the control server 20 may determine that the situation in which the GNSS signal cannot be received (or reception of the GNSS signal is unstable) has been resolved.

In a case where it is not determined in the above step S301 that a specific event has been canceled (step S301: No), the control unit 203 of the control server 20 ends the processing. On the other hand, in a case where it is determined in the above step S301 that a specific event has been canceled for a certain mobile terminal 10 (step S301: Yes), the control unit 203 of the control server 20 performs control to return the communication resources of the mobile terminal 10 to the communication resources before occurrence of the specific event (step S302). In other words, the control unit 203 performs control to return the communication resources of the mobile terminal 10 to the communication resources before the increase. However, this is an example, and the present invention is not limited thereto. The control unit 203 of the control server 20 may perform control other than control to return the communication resources to the communication resources before the occurrence of the specific event as long as the communication resources of the mobile terminal 10 are reduced for the mobile terminal 10 in which the specific event has been canceled. For example, control such as changing the network to a route with lower network quality, lowering the bandwidth, lowering the priority, or the like, may be performed. In addition to this, for example, control of switching the line to a best effort type line may be performed.

In a case where the communication resources of a certain mobile terminal 10 are reduced by the above step S302, the NW information of the first NW information data including the terminal ID of the mobile terminal 10 is also updated.

As described above, the control server 20 according to the present embodiment reduces the communication resources of the mobile terminal 10 for the mobile terminal 10 in a situation where the GNSS signal can be received (or reception of the GNSS signal is stable). This results in making it possible to prevent real-time or high-rate or high-accuracy sensor information from being transmitted from the mobile terminal 10, so that it is possible to prevent congestion, or the like, of the communication network 50. Note that, in general, the GNSS signal is data having a lower capacity than the sensor information, and thus, even if the communication resources are reduced, the GNSS positioning on the control server 20 side is not affected (or the influence is negligible).

### MODIFICATIONS

### Modification 1

In the above embodiment, the communication resources of the mobile terminal 10 are controlled according to whether or not a GNSS signal can be received, but the present invention is not limited thereto, and for example, server resources (CPU resources, GPU resources, and memory resources), or the like, on the control server 20 side may be controlled together with the communication resources (or instead of the communication resources).

In other words, for example, the available server resources of the mobile terminal 10 may be increased for the mobile terminal 10 in a situation in which the GNSS signal cannot be received (or reception of the GNSS signal is unstable), and the server resources may be reduced for the mobile terminal 10 not in the situation. This is because, in general, non-GNSS positioning (in particular, image positioning, and the like,) requires relatively many server resources.

### Modification 2

In the above embodiment, the communication resources of the mobile terminal 10 are controlled according to whether or not a GNSS signal can be received, but in addition to this, for example, a function included in the mobile terminal 10 may be exerted.

For example, it is assumed that the mobile terminal 10 includes a camera (as an example, a wearable device with a camera, or the like, is assumed). In this event, when a GNSS signal cannot be received (or reception of the GNSS signal is unstable), control of activating the camera may be performed. On the other hand, when a GNSS signal can be received (or reception of the GNSS signal becomes stable), control of stopping the camera may be performed.

As a result, only when a GNSS signal cannot be received (or reception of the GNSS signal is unstable), sensor information (such as an image captured by the camera) is transmitted from the mobile terminal 10 to the control server 20, and non-GNSS positioning using the sensor information can be performed. Thus, when a GNSS signal can be received (or reception of the GNSS signal is stable), the communication resources and the server resources of the mobile terminal 10 can be reduced.

### CONCLUSION

As described above, the control server 20 according to the present embodiment dynamically controls the resources available to the mobile terminal 10 according to whether or not the mobile terminal 10 connected via the communication network 50 can stably receive a GNSS signal. This makes it possible to implement efficient use of resources in the entire system. It is therefore possible to, for example, prevent deterioration in service quality due to shortage in resources.

### <Specific Example of Implementing Efficient Use of Resources in Entire System>

In the above embodiment, a case where the mobile terminal 10 dynamically controls resources available to the mobile terminal 10 according to whether or not the mobile terminal can stably receive a GNSS signal without assuming a specific scene has been described. On the other hand, such resource control may be performed in various ways depending on the type and classification of the mobile terminal 10, the type and classification of resources, and what viewpoint (economic efficiency, convenience, etc.) is to be emphasized. For example, in a case where various types of mobile terminals 10 such as a drone and an automobile are mixed, it is conceivable to control resources in the mobile terminals 10 of the type of drone, and it is also conceivable to control resources across different types of mobile terminals 10. Furthermore, content of the control can be considered in various ways.

Thus, in the following, as an example, two viewpoints of a viewpoint of a provider of the NW/server resources and a viewpoint of a user of the NW/server resources are assumed, and a specific example of the resource control will be described.

### (1) Viewpoint of Provider of NW/Server Resources

It is conceivable to perform resource control so as to minimize cost and operation cost of the resources within a range satisfying requirements on the user side of the NW/server resources (for example, resource requirements necessary for a service to be provided to the user, and the like). This is a viewpoint focusing on economic efficiency.

Note that, resource control itself also involves a cost, and thus, for example, whether or not to perform resource control each time a situation in which a GNSS signal cannot be received occurs, how much to perform resource allocation, and the like, are appropriately determined in consideration of allowable cost.

### (2) Viewpoint of User of NW/Server Resources.

It is conceivable to perform resource control so as to minimize cost and operation cost of the resources within a range satisfying requirements for achieving the purpose of use of the NW/server resources (for example, resource requirements necessary for service provision, and the like). This is also a viewpoint focusing on economic efficiency.

For example, as an example of such resource control, there is control so as to use resources on a flat-rate basis as much as possible without using resources on a pay-per-use basis as much as possible. In addition, as another example, there is control so as to use only low-cost resources that satisfy the above requirements without using overspec and high-cost resources as much as possible.

In addition to this, for example, the following is also conceivable. In other words, there are a flat-rate NW (where it is assumed that the NW is available for up to two drones) and a pay-per-use NW, and both NWs satisfy resource requirements, and the like, necessary for service provision. In this event, in a case where the route change is performed so that one of the two drones using the flat-rate NW uses the NW on a pay-per-use basis for some reason (for example, coverage, and the like), it is conceivable to perform resource control so that one of the drones using the NW on the pay-per-use basis uses the flat-rate NW.

In the above description, a drone is assumed as the mobile terminal 10, and an example of resource control for implementing efficient use of resources in the entire plurality of drones has been described. However, this is similarly applicable to a plurality of types of mobile terminals 10. In other words, for example, in a case where there are various types of mobile terminals 10 such as an automobile, a drone, construction machine, and agricultural machine, resource control for implementing efficient use of resources in the entire mobile terminals 10 may be performed. More generally, resource control for implementing efficient use of resources in various mobile terminals 10 as a whole across units such as various types, classifications, users, and the like, may be performed.

It goes without saying that the above (1) and (2) are both examples. In addition to these, various kinds of resource control can be considered according to various specific scenes or specific situations.

The present invention is not limited to the above embodiment specifically disclosed, and various modifications and changes, combinations with known technologies, and the like, can be made without departing from the scope of the claims.

### REFERENCE SIGNS LIST

1 Communication control system
10 Mobile terminal
20 Control server
30 Position information database
40 NW information database
50 Communication network
101 GNSS signal reception unit
102 Sensor information acquisition unit
103 Communication unit
104 Terminal-side positioning calculation unit
201 Communication unit
202 Server-side positioning calculation unit
203 Control unit
E Edge/cloud environment

1. A control device to be connected to a mobile terminal including at least a GNSS receiver via a communication network, the control device comprising:
a hardware processor configured to control resources available to the mobile terminal in accordance with a reception status of a GNSS signal in the GNSS receiver included in the mobile terminal.

2. The control device according to claim 1,
wherein the hardware processor is configured to
perform control to increase the resources in a case where the GNSS receiver included in the mobile terminal is unable to receive the GNSS signal, and
perform control to reduce the resources in a case where the GNSS receiver included in the mobile terminal is able to receive the GNSS signal.

3. The control device according to claim 2, wherein the hardware processor is configured to
receive at least one of the GNSS signal received by the GNSS receiver included in the mobile terminal or sensor information acquired by sensor equipment included in the mobile terminal;
measure position information of the mobile terminal using at least one of the GNSS signal or the sensor information and
determine whether or not the GNSS receiver included in the mobile terminal is able to receive the GNSS signal on a basis of whether or not the position information is measured from the GNSS signal.

4. The control device according to claim 1, wherein the resources include at least one of a bandwidth and priority of the communication network available to the mobile terminal.

5. The control device according to claim 1, wherein the resources include at least one of calculation resources and memory resources of a cloud server available to the mobile terminal.

6. The control device according to claim 1, wherein the hardware processor is configured to
further control execution or stop of a function of the mobile terminal in accordance with a reception status of the GNSS signal in the GNSS receiver included in the mobile terminal.

7. A control method to be executed by a control device to be connected to a mobile terminal including at least a GNSS receiver via a communication network, the control method comprising:
controlling resources available to the mobile terminal in accordance with a reception status of a GNSS signal in the GNSS receiver included in the mobile terminal.

8. A non-transitory computer-readable memory medium storing a program for causing a control device to be connected to a mobile terminal including at least a GNSS receiver via a communication network to execute a process, the process comprising:
controlling resources available to the mobile terminal in accordance with a reception status of a GNSS signal in the GNSS receiver included in the mobile terminal.
